(19) United States
(12) Patent Application Publication
(10) Pub. No.: US 2024/0143369 A1
(43) Pub. Date: May 2, 2024

(54) USING RULE ENGINE WITH PUSH MECHANISM FOR CONFIGURATION DATA OF A CONTAINERIZED COMPUTING CLUSTER

(71) Applicant: Red Hat, Inc., Raleigh, NC (US)

(72) Inventors: Luca Molteni, Cernusco Sul Naviglio (IT); Matteo Mortari, Binasco (IT)

(21) Appl. No.: 17/975,873

(22) Filed: Oct. 28, 2022

(51) Int. Cl. G06F 9/455

(52) U.S. Cl. CPC G06F 9/45558; G06F 2009/45595

(57) ABSTRACT

A method includes retrieving, by a processing device, new configuration data of a containerized computing cluster, wherein the containerized computing cluster comprises a plurality of virtualized computing environments running on one or more host computer systems, and wherein the new configuration data reflects a change of a configuration of the containerized computing cluster with respect to a previous configuration of the containerized computing cluster; storing the new configuration data into a working memory, wherein the working memory is in a stateful session; extracting a fact from the new configuration data; evaluating a rule against the fact, wherein the rule specifies a condition and an action to perform if the condition is satisfied; and responsive to determining that the condition specified by the rule matches the fact, performing the action specified by the rule, wherein the action comprises a notification regarding a change of a state of the containerized computing cluster.

### TECHNICAL FIELD

The present disclosure is generally related to rule engines, and more particularly, to using rule engine with push mechanism for configuration data of a containerized computing cluster.

### BACKGROUND

The development and application of rule engines is one branch of Artificial Intelligence (AI). Broadly speaking, a rule engine processes information by applying rules to data objects (also known as facts). A rule is a logical construct for describing the operations, definitions, conditions, and/or constraints that apply to some predetermined data to achieve a goal. Various types of rule engines have been developed to evaluate and process rules.

### BRIEF DESCRIPTION OF THE DRAWINGS

The present disclosure is illustrated by way of example, and not by way of limitation, and can be more fully understood with reference to the following detailed description when considered in connection with the figures in which:

FIG. 1 depicts a high-level component diagram of an example of a computer system architecture, in accordance with one or more aspects of the present disclosure.

FIG. 2 depicts a component diagram of an example of a container orchestration cluster, in accordance with one or more aspects of the present disclosure.

FIG. 3 depicts an example of a rule, in accordance with one or more aspects of the present disclosure.

FIGS. 4-5 depict flow diagrams of example methods for using a rule engine with push mechanism for new data in a containerized computing cluster, in accordance with one or more aspects of the present disclosure.

FIG. 6 depicts a block diagram of an example computer system operating in accordance with one or more aspects of the present disclosure.

### DETAILED DESCRIPTION

Described herein are methods and systems for using rule engine with push mechanism for new configuration data of a containerized computing cluster. Container orchestration systems, such as Kubernetes, can be used to manage containerized workloads and services, and can facilitate declarative configuration and automation. Container orchestration systems can have built-in features to manage and scale stateless applications, such as web applications, mobile backends, and application programming interface (API) services, without requiring any additional knowledge about how these applications operate. For stateful applications, like databases and monitoring systems, which may require additional domain-specific knowledge, container orchestration systems can use operators, such as Kubernetes Operator, to scale, upgrade, and reconfigure stateful applications. An operator refers to an application for packaging, deploying, and managing another application within a containerized computing services platform associated with a container orchestration system. A containerized computing services platform refers to an enterprise-ready container platform with full-stack automated operations that can be used to manage, e.g., hybrid cloud and multicloud deployments. A containerized computing services platform uses operators to autonomously run the entire platform while exposing configuration natively through objects, allowing for quick installation and frequent, robust updates.

“Operator” can encode the domain-specific knowledge needed to scale, upgrade, and reconfigure a stateful application into extensions (e.g., Kubernetes extensions) for managing and automating the life cycle of an application. More specifically, applications can be managed using an application programming interface (API), and operators can be viewed as custom controllers (e.g., application-specific controllers) that extend the functionality of the API to generate, configure, and manage applications and their components within the containerized computing services platform. In a container orchestration system, a controller is an application that implements a control loop that monitors a current state of a cluster, compares the current state to a desired state, and takes application-specific actions to match the current state with the desired state in response to determining the state does not match the desired state. An operator, as a controller, can continue to monitor the target application that is being managed, and can automatically back up data, recover from failures, and upgrade the target application over time. Additionally, an operator can perform management operations including application scaling, application version upgrades, and kernel module management for nodes in a computational cluster with specialized hardware. Accordingly, operators can be used to reduce operational complexity and automate tasks within a containerized computing services platform, beyond the basic automation features that may be provided within a containerized computing services platform and/or container orchestration system.

A container orchestration system may include clusters, each of which includes a plurality of virtual machines or containers running on one or more host computer systems. In some systems, the control planes of the clusters enable interfacing with API in order to be notified of control plane events, such as new resources being added, modified, removed, and events pertaining to specific resources being logged. However, creating meaningful integration with such API requires the developer to write procedural programming language that are tied both to the cluster and the business environment settings. As a consequence, such integration might be difficult to be implemented, modified, and shared across other developers, and difficult to be overviewed by the business stakeholders.

Aspects of the present disclosure address the above and other deficiencies by using a rule engine with push mechanism for new configuration data of a containerized computing cluster. A rule engine can evaluate one or more rules against one or more facts (e.g., objects), where each rule specifies, by its left-hand side, a condition (e.g., at least one constraint) and, by its right-hand side, at least one action to perform if the condition of the rule is satisfied. An object (also referred to as data object) is a set of one or more data items organized in a specified format (e.g., representing each fact of a set of facts by a respective element in a tuple). An object may further include one or more placeholders for elements, where each element represents, for example, a characteristic of an object. A push mechanism for new configuration data of a containerized computing cluster may be employed to retrieve new configuration data of a containerized computing cluster, where the configuration data of a containerized computing cluster refers to data that needs to be accessed by the containerized computing cluster for normal operations, including, for example, cluster desired states and cluster current states (such as which applications are running and which container images they use, which resources are available for them, and other configuration details) and their replicas. New configuration data may reflect a change of configuration data compared to previous configuration data of the cluster.

The present disclosure provides a way to create additional rules in the control plane of a cluster by retrieving (i.e., push) new configuration data of a cluster from a data store (e.g., etcd). These rules allow the developers to use the change of the configuration data of the cluster in a way that reflects a specific control over the cluster. A cluster system according to the present disclosure retrieves such data whenever such data is updated in the data store of the cluster and then inserts it inside a working memory in a stateful session. The working memory in a stateful session can function as a memory to store data during the session and maintain the data after the session is over. The component in the cluster system can extract objects (i.e., facts) from the retrieved data and assert the objects (i.e., asserted objects) to a rule engine that can evaluate rules against the asserted objects. For example, the rules may indicate to monitor a change in one or more states of the cluster (e.g., the change of the number of CPUs used in the cluster) and instruct to perform certain actions when the change of the state reflected by the asserted objects satisfies a constraint specified in the rule regarding the change of that state. As such, the cluster system can evaluate the rules against the asserted objects, and perform the corresponding actions specified by the matched rules. Therefore, the cluster system allows to use rules that can monitor a change in one or more states of a cluster and provide corresponding actions to implement the meaningful integration mentioned above. For example. it allows the developers to encode the stakeholders' requirements and/or Service-Level Agreements (SLAs) faster, by focusing on the declarative logic provided by the rule, and also handling the inner working of complex event processing (CEP) (e.g., changes in data) through the rule engine.

Advantages of the present disclosure include improving efficiency and speed of providing customized control over a cluster and reducing the usage of computational resources. Using the rule engine within push mechanism for new data in the cluster provides an efficient way by using decent or small amount of data (e.g., a change in data), for example, to monitor the cluster and assure the cluster working following the rules. The use of the amount of data corresponding to new data in the cluster can also avoid consuming excessive computing resources, for example, the bandwidth of memory recourses. Further, by integrating the monitoring notification mechanism of the cluster, every resource and events can be used in the rules, and consequently the criteria(s) for SLAs can also be encoded as a rule.

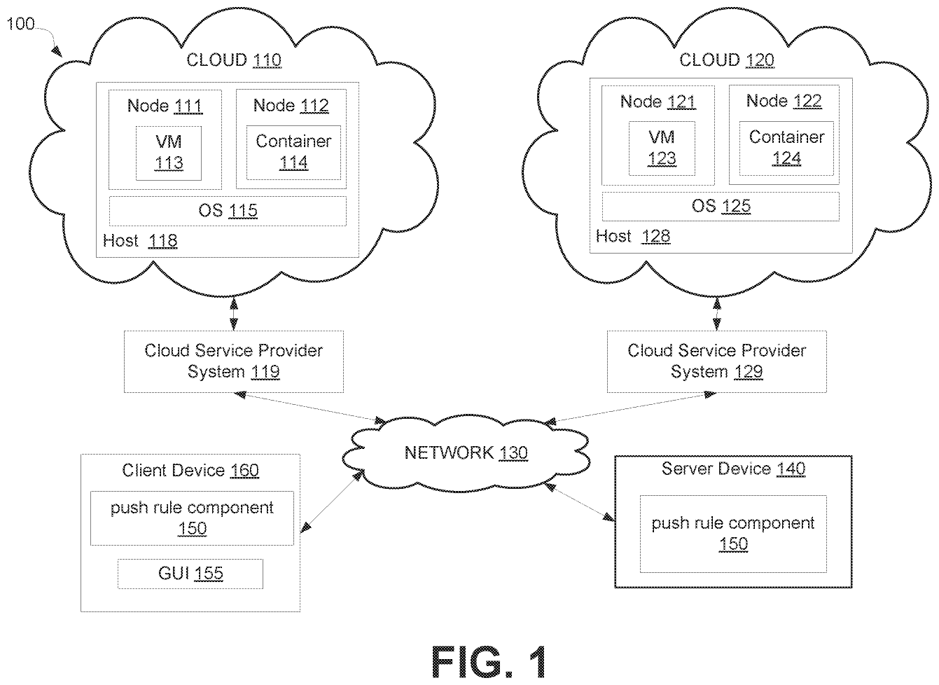

FIG. 1 is a block diagram of a network architecture 100 in which implementations of the disclosure may operate. In some implementations, the network architecture 100 may be used in a containerized computing services platform. A containerized computing services platform may include a Platform-as-a-Service (PaaS) system, such as Red Hat® OpenShift®. The PaaS system provides resources and services (e.g., micro-services) for the development and execution of applications owned or managed by multiple users. A PaaS system provides a platform and environment that allow users to build applications and services in a clustered compute environment (the “cloud”). Although implementations of the disclosure are described in accordance with a certain type of system, this should not be considered as limiting the scope or usefulness of the features of the disclosure. For example, the features and techniques described herein can be used with other types of multi-tenant systems and/or containerized computing services platforms.

As shown in FIG. 1, the network architecture 100 includes one or more cloud-computing environment 110, 120 (also referred to herein as a cloud(s)) that includes nodes 111, 112, 121, 122 to execute applications and/or processes associated with the applications. A “node” providing computing functionality may provide the execution environment for an application of the PaaS system. In some implementations, the “node” may include a virtual machine (VMs 113, 123) that is hosted on a physical machine, such as host 118, 128 implemented as part of the clouds 110, 120. For example, nodes 111 and 112 are hosted on physical machine of host 118 in cloud 110 provided by cloud provider 119. Similarly, nodes 121 and 122 are hosted on physical machine of host 128 in cloud 120 provided by cloud provider 129. In some implementations, nodes 111, 112, 121, and 122 may additionally or alternatively include a group of VMs, a container (e.g., container 114, 124), or a group of containers to execute functionality of the PaaS applications. When nodes 111, 112, 121, 122 are implemented as VMs, they may be executed by operating systems (OSs) 115, 125 on each host machine 118, 128. While two cloud providers systems have been depicted in FIG. 1, in some implementations more or fewer cloud service provider systems (and corresponding clouds) may be present.

In some implementations, the host machines 118, 128 can be located in data centers. Users can interact with applications executing on the cloud-based nodes 111, 112, 121, 122 using client computer systems (not pictured), via corresponding client software (not pictured). Client software may include an application such as a web browser. In other implementations, the applications may be hosted directly on hosts 118, 128 without the use of VMs (e.g., a “bare metal” implementation), and in such an implementation, the hosts themselves are referred to as “nodes”.

In various implementations, developers, owners, and/or system administrators of the applications may maintain applications executing in clouds 110, 120 by providing software development services, system administration services, or other related types of configuration services for associated nodes in clouds 110, 120. This can be accomplished by accessing clouds 110, 120 using an application programmer interface (API) within the applicable cloud service provider system 119, 129. In some implementations, a developer, owner, or system administrator may access the cloud service provider system 119, 129 from a client device (e.g., client device 160) that includes dedicated software to interact with various cloud components. Additionally, or alternatively, the cloud service provider system 119, 129 may be accessed using a web-based or cloud-based application that executes on a separate computing device (e.g., server device 140) that communicates with client device 160 via network 130.

Client device 160 is connected to host 118 in cloud 110 and host 128 in cloud 120 and the cloud service provider systems 119, 129 via a network 130, which may be a private network (e.g., a local area network (LAN), a wide area network (WAN), intranet, or other similar private networks) or a public network (e.g., the Internet). Each client 160 may be a mobile device, a PDA, a laptop, a desktop computer, a tablet computing device, a server device, or any other computing device. Each host 118, 128 may be a server computer system, a desktop computer, or any other computing device. The cloud service provider systems 119, 129 may include one or more machines such as server computers, desktop computers, etc. Similarly, server device 140 may include one or more machines such as server computers, desktop computers, etc.

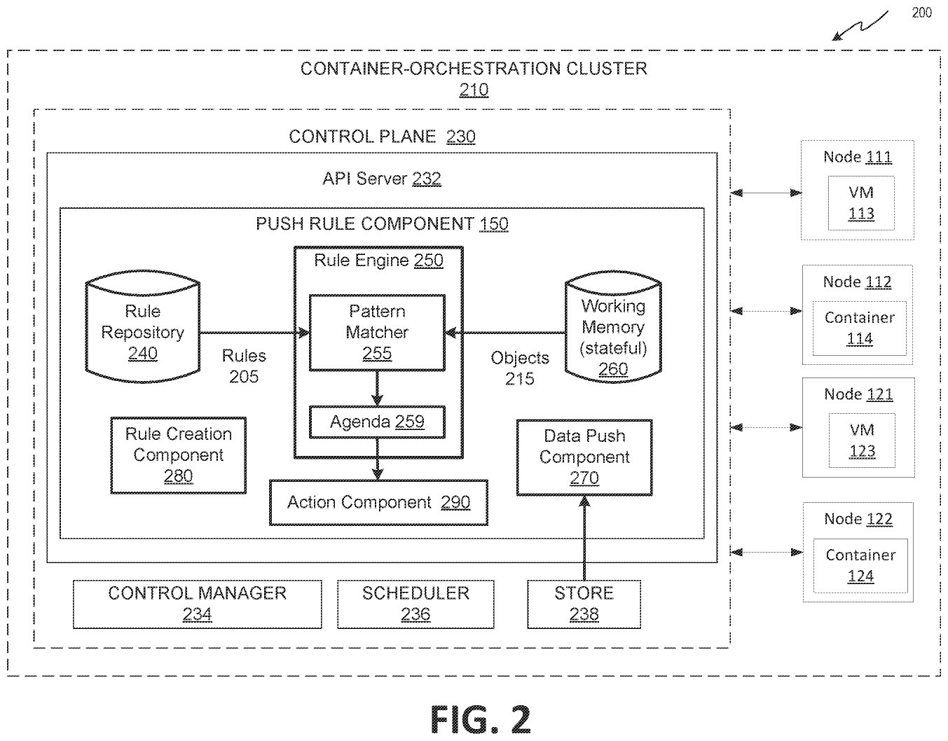

In some implementations, the client device 160 may include a push rule component 150, which can implement a rule engine with push mechanism for new data in a cluster. The details regarding push rule component 150 using rule engine with push mechanism will be described with respect to FIG. 2. Push rule component 150 may be an application that executes on client device 160 and/or server device 140. In such instances, push rule component 150 can function as a web-based or cloud-based application that is accessible to the user via a web browser or thin-client user interface that executes on client device 160. For example, the client machine 160 may present a graphical user interface (GUI) 155 (e.g., a webpage rendered by a browser) to allow users to input data to be processed by the push rule component 150. The process performed by push rule component 150 can be invoked in a number of ways, such as, e.g., via a web front-end and/or a Graphical User Interface (GUI) tool. In some implementations, a portion of push rule component 150 may execute on client device 160 and another portion of push rule component 150 may execute on server device 140. While aspects of the present disclosure describe push rule component 150 as implemented in a PaaS environment, it should be noted that in other implementations, push rule component 150 can also be implemented in an Infrastructure-as-a-Service (IaaS) environment associated with a containerized computing services platform, such as Red Hat® OpenStack®. The functionality of push rule component 150 will now be described in further detail below with respect to FIG. 2

FIG. 2 illustrates an example system 200 that implements a push rule component 150. The system 200 includes a cluster 210. The cluster 210 is managed by a container orchestration system, such as Kubernetes. Using clusters can allow a business entity having multiple services requirements to manage containerized workloads and services and facilitate declarative configuration and automation that is specific to one service among the multiple services.

The cluster 210 includes a control plane 230 and a collection of nodes (e.g., nodes 111, 112, 121, 122). The control plane 230 can make global control and management decisions about a cluster through components described below. The control plane 230 is responsible for maintaining the desired state (i.e., a state desired by a client when running the cluster) of the cluster 210, such as which applications are running and which container images they use, which resources should be made available for them, and other configuration details. The control plane 230 may include an API server 232, a control manager 234, a scheduler 236, and a store 238. The API server 232 can be used to define the desired state of the cluster 210. For example, the desired state can be defined by configuration files including manifests, which are JSON or YAML files that declare the type of application to run and the number of replicas required to run. The API server can provide an API, for example, using JSON over HTTP, which provides both the internal and external interface. The API server can process and validate requests and update the state of the API objects in a persistent store, thereby allowing clients to configure workloads and containers across worker nodes. The API server can monitor the cluster 210, roll out critical configuration changes, or restore any divergences of the state of the cluster 210 back to what the deployer declared.

The control manager 234 can manage a set of controllers, such that each controller implements a corresponding control loop that drives the actual cluster state toward the desired state (e.g., where the desired state requires two memory resources per application, if the actual state has one memory resource allocated to one application, another memory resource will be allocated to that application), and communicates with the API server to create, update, and delete the resources it manages (e.g., pods or service endpoints). The scheduler 236 can select a node for running an unscheduled pod (a basic entity that includes one or more containers/virtual machines and managed by the scheduler), based on resource availability. The scheduler 236 can track resource use on each node to ensure that workload is not scheduled in excess of available resources. The store 238 is a persistent, lightweight, distributed, key-value data store that stores the configuration data of the cluster, representing the overall state of the cluster at any given point of time.

The API server 232 can include a push rule component 150 that implements a rule engine with push mechanism for new data in a cluster according to the present disclosure. The push rule component 150 includes a data push component 270 that retrieves new data from the store 238 when any change to the data of the cluster in the store 238 is detected and stores data in a working memory 260, a rule creation component 280 that creates, for example, through a GUI by a client, one or more rules regarding the retrieved data and provides the rules to a rule repository 240, a rule engine 250 that evaluates the rules, for example, by comparing the rule with a fact from the retrieved data, the rule repository 240 and a working memory 260 in communication with the rule engine 250 for the evaluation, and an action component 290 that instructs to perform or performs an action produced from evaluating the rules. Each component will be described in detail below.

The rule engine 250 can be a software that processes information by applying rules to data objects (also known as facts). Initially, the rule engine 250 creates a stateful session for the working memory 260. A session allows a series of interactions with the rule engine over a predetermined period of time in which data objects asserted into the session are evaluated against rules. A session may be stateful or stateless. In a stateful session, a rule engine can assert and modify the data objects over time, add and remove the objects, and evaluate the rules; these steps can be repeated during the session, for example, over multiple iterations. In a stateless session, after a rule engine have added rules and asserted data objects at the beginning of the session, the evaluation of rules can be invoked only once; it is possible to initiate a new stateless session, where rules and data objects need to be asserted again to perform a new evaluation of rules. As such, according to the present disclosure, in some implementations, a fireUntilHalt mode may be used within the stateful session for the working memory 260. The fireUntilHalt mode refers to a mechanism of firing rules in the rule engine 250 so that rules are kept firing until a halt command is issued in the rule engine 250.

The data push component 270 can detect a change in data of the cluster 210 stored in the store 238, and in response, retrieve new data from the store 238 in the cluster 210. New data can include any data representing a change from previous data, including modified data, added data, deleted data, etc. In some implementations, in response to that the store 238 stores new data regarding the cluster 210, the data push component 270 accesses the new data in the store 238. The data push component 270 can store the retrieved data (i.e., the new data retrieved from the store 238 regarding the cluster 210) in the working memory 260. In some implementations, the data push component 270 can monitor the new configuration data in the store 238 of the containerized computing cluster and determine whether the new configuration data in the store 238 satisfies a threshold condition (e.g., at a specific time after last retrieval of new configuration, or a workload change exceeding a certain percentage). The data push component 270 can, in response to determining that the new configuration data in the store 238 satisfies the threshold condition, retrieved the new data from the store 238 in the cluster.

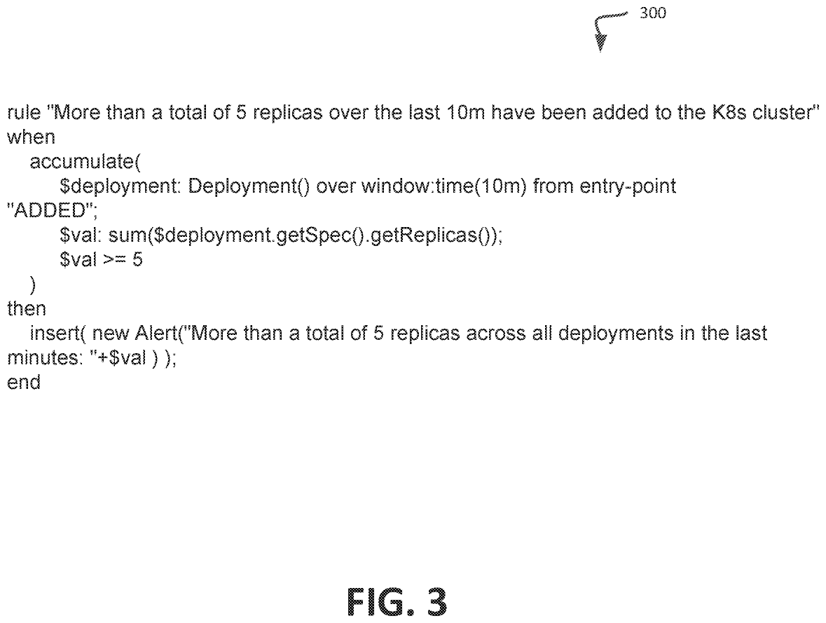

The rule engine 250 can extract objects 215 from the retrieved data. The objects 215 can indicate a change of a state of the cluster 210. In the example of FIG. 3, the state is related to the total number of replicas in the cluster, and the object reflects a change of the total number of replicas in the cluster. The objects 215 can be of different types, including plain text, Extended Markup Language (XML) documents, database tables, Plain Old Java Objects (POJOs), predefined templates, comma separated value (CSV) records, custom log entries, Java Message Service (JMS) messages, etc. In some implementations, the objects can be in a serialized form, such as in a binary stream, and the rule engine 250 may deserialize the binary stream and convert it into a format useable by the rule engine 250. In some implementations, the objects can be written to a binary stream via standard readObject method and writeObject method.

The rule creation component 280 can be implemented as, for example, a tool used by the end user to define the rules, including a text editor, a visual editor, etc. and can be used to create one or more rules regarding one or more states of the cluster 210, where each rule will be evaluated against the asserted objects. As an illustrating example, a rule can reflect a way that the user intends to use the new data of a cluster (i.e., a change in the cluster), and an asserted object can be a specific state that can be determined whether fit the rule for the intended use. The details regarding the rules and data objects will be described below with respect to the rule repository 240, the working memory 260, and the rule engine 250.

The rule creation component 280 can store the rules in the rule repository 240. The rule repository 240 (also referred to as the production memory) may include an area of memory and/or secondary storage that stores the rules that will be used to evaluate against objects (e.g., facts). The rule repository 240 may include one or more file systems, may be a rule database, may be a table of rules, or may be some other data structure for storing a rule set.

The rule repository 240 can store rules created by the rule creation component 280 and provide rules 205 to the rule engine for evaluation. Each rule of the rules 205 has a left-hand side that corresponds to the constraints of the rule and a right-hand side that corresponds to one or more actions to perform if the constraints of the rule are satisfied. Techniques to specify rules can vary, including using Java objects to describe rules, using a Domain Specific Language (DSL) to express rules, or using a GUI to enter rules. The rules 205 can be defined using a scripting language or other programming language, and can be in a format of a data file or an Extended Markup Language (XML) file, etc. An example of a rule is illustrated with respect to FIG. 3.

The rule engine 250 can receive the rules 205 from the rule repository 240 and evaluate the rules 205. In some implementations, the rule engine 250 includes a pattern matcher 255 to evaluate the rules 205 from the rule repository 240 against objects 215 from the working memory 260. The evaluation may involve comparing the objects with the constraints of rules and storing the matched rules and actions.

To evaluate the rules, the rule engine 250 may use, e.g., a Rete algorithm that defines a way to organize objects in a pre-defined structure and allows the rule engine to generate conclusions and trigger actions on the objects according to the rules. Specifically, the rule engine 250, via the pattern matcher 255, may implement a logical network (such as a Rete network) to process the rules and the objects. A logical network may be represented by a network of nodes. For example, each node (except for the root node) in a Rete network corresponds to a pattern appearing in the left-hand side (the condition part) of a rule, and the path from the root node to a leaf node defines a complete rule left-hand side of a rule.

The pattern matcher 255 can use the Rete network to evaluate the rules against the objects. For example, the pattern matcher 255 receives from the rule repository 240 one of a plurality of rules 205, and the pattern matcher 255 receives at least one input object 215 from working memory 260. The pattern matcher 255 may have each network node corresponding to a part of the condition (e.g., one constraint) appearing in the left-hand side of the rule and a path from the root node to the leaf node corresponding to the whole condition (e.g., all constraints) in the complete left-hand side. The pattern matcher 255 may allow the object 215 from the working memory 260 propagate through the logical network by going through each node and annotate the node when the object matches the pattern in that node. As the object 215 from the working memory 260 propagate through the logical network, the pattern matcher 255 evaluates the object 215 against the network node by comparing the object 215 to the network node and creates an instance of the network node to be executed based on the object 215 matching the network node. When the object 215 causes all of the patterns for the nodes in a given path to be satisfied, a leaf node is reached, and the corresponding rule is determined to have been matched by the object.

Fully matched rules and/or constraints may result in actions and are placed into the agenda 259. The agenda 259 is a data store, which provides a list of rules to be executed and the objects on which to execute the rules. The rules engine 250 may iterate through the agenda 259 to trigger the actions sequentially. Alternatively, the rules engine 250 may execute (or fire) the actions in the agenda 259 randomly. As such, the rule engine 250 can receive the rules 205 from the rule repository 240 and evaluate the rules 205 against objects 215 from the working memory 260, and the matched rules and actions from the evaluation are saved in the agenda 259.

The action component 290 can receive the matched rules and determine or take corresponding actions that are indicated in the matched rules. In some implementations, the action includes a notification regarding the state of the containerized computing cluster, and the notification can be output through a user interface to a client using the cluster or an administrator managing the cluster so that corrective operations can be performed in response to the notification. For example, the notification may be in a form of an alert shown in FIG. 3. In some implementations, the action includes self-healing mechanism regarding a state of the containerized computing cluster, which can correct or remedy an error or undesired status of the state of the cluster. For example, the self-healing mechanism can include adding new resources (e.g., CPU or memory) to the cluster 210, or providing a new node to the cluster 210.

FIG. 3 depicts an example of a rule regarding the retrieved data, in accordance with one or more aspects of the present disclosure. As the example illustrated in FIG. 3, a user can monitor a change in the state of the replicas in the cluster, for example, a total number of the replicas requested to the cluster within a certain time period, and to implement it, the rule creation component 280 may write into a rule with a left-hand side stating a constraint that the total number of the virtual CPUs from all deployments is higher than or equal to a specific threshold (e.g., $val>=5) and a right-hand side stating an action of generating an alert to a user, for example, through a user interface.

The rule shown in FIG. 3 are specified in multiple parameters, which would have otherwise required excessive manually coding for interacting with the control plane API, including filtering only for positive replicas, monitoring for over the last ten minutes only, for a specific type of resource for Deployment, accumulating the sum of the replicas number across all those Deployments. As such, the rules instruct that if the sum number of the replicas is above a certain threshold, firing an alert, for example, for a stakeholder service-level agreement. Such rules can prevent the situation when too many replicas are being requested to the cluster (e.g., a developer firing off too many Deployments during their testing without realizing it). This approach allows the developers to encode with smart rules for complex event processing (CEP), instead of manually coding excessive mixed operational procedural code and stakeholder-related logic.

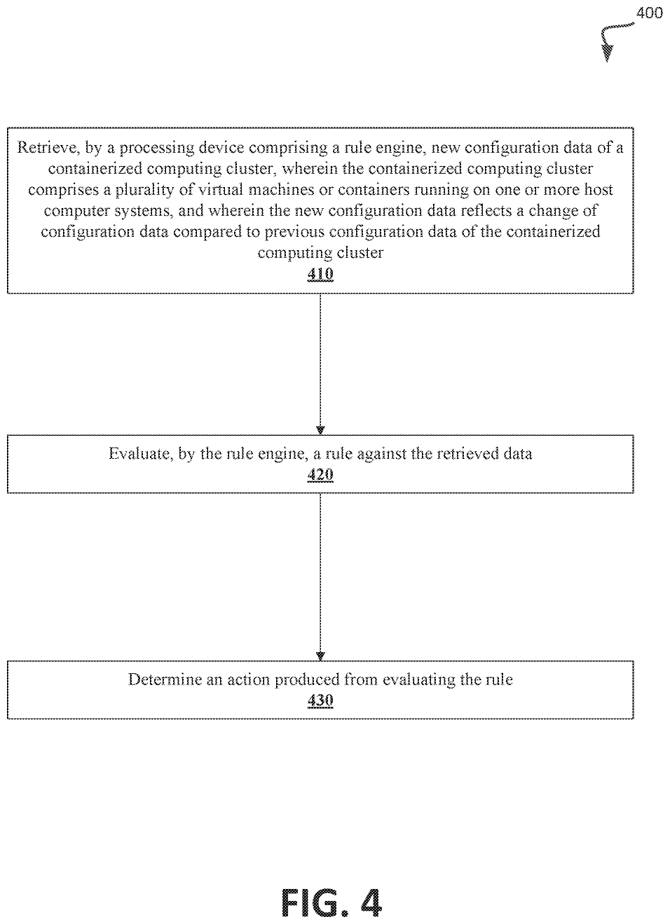

FIG. 4 depicts a flow diagram of an illustrative example of a method 400 for implementing a rule engine with push mechanism to retrieve new data of a containerized computing cluster, in accordance with one or more aspects of the present disclosure. Method 400 and each of its individual functions, routines, subroutines, or operations may be performed by one or more processors of the computer device executing the method. In certain implementations, method 400 may be performed by a single processing thread. Alternatively, method 400 may be performed by two or more processing threads, each thread executing one or more individual functions, routines, subroutines, or operations of the method. In an illustrative example, the processing threads implementing method 400 may be synchronized (e.g., using semaphores, critical sections, and/or other thread synchronization mechanisms). Alternatively, the processes implementing method 400 may be executed asynchronously with respect to each other.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media.

Method 400 may be performed by processing devices of a server device or a client device. The processing device includes a rule engine that is capable to create rules and evaluate rules. At operation 410, the processing device retrieves new configuration data of a containerized computing cluster, responsive to detecting the new configuration data, wherein the containerized computing cluster comprises a plurality of virtualized computing environments (e.g., virtual machines or containers) running on one or more host computer systems. The new configuration data of a containerized computing cluster includes a change in the configuration data of the containerized computing cluster compared to the previous configuration data of the containerized computing cluster. In some implementations, the processing device may detect the new configuration data when a change in data of the containerized computing cluster in a data store (e.g., store 238) is detected. In some implementations, the processing logic may access a data store of the containerized computing cluster to retrieve the new data of the containerized computing cluster.

At operation 420, the processing logic evaluates a rule against the retrieved data. As described previously, the processing logic can create one or more rules that can be evaluated against the retrieved data. Each rule may indicate a way to use the retrieved data. Each rule includes a predicate associated with a constraint on the left-side hand and a production on the right-side hand. Each rule may be defined based on an executable model language, such as, for example, an executable model that is used to generate Java source code representation of the rule, providing faster startup time and better memory allocation.

The processing logic can evaluate the rule described above against asserted objects extracted from the retrieved data from a working memory. The processing logic may extract the asserted objects from the retrieved data. The extraction may involve selecting specific data from the retrieved data. The extraction may involve calculating some data selected from the retrieved data to obtain the asserted objects. For example, the asserted object may be the data corresponding to a change in the number of the replicas in the cluster as shown in FIG. 3. In another example, the asserted object may be a change in the number of the CPU resources currently in use and/or the number of the memory resources currently in use in the cluster.

The processing logic may evaluate the rule by determining whether the condition specified by each rule matches an asserted object. The processing logic may evaluate the rule by comparing at least one asserted object to at least one constraint of the rule and store the information when there is a match from the comparison. When there is a match of the evaluated rule and the asserted object, the processing logic may store the matched rule.

At operation 430, the processing logic determines an action produced from evaluating the rule. The processing logic determines the action according to a production side (i.e., right-side hand) of a matched rule. The action may include a notification, a corrective operation, any other actions, or in combination there. In some implementations, the processing logic may generate a notification (e.g., an alert) regarding a change of a state of the containerized computing cluster. In some implementations, the processing logic may perform a corrective action (e.g., a self-healing operation) regarding a state of the containerized computing cluster.

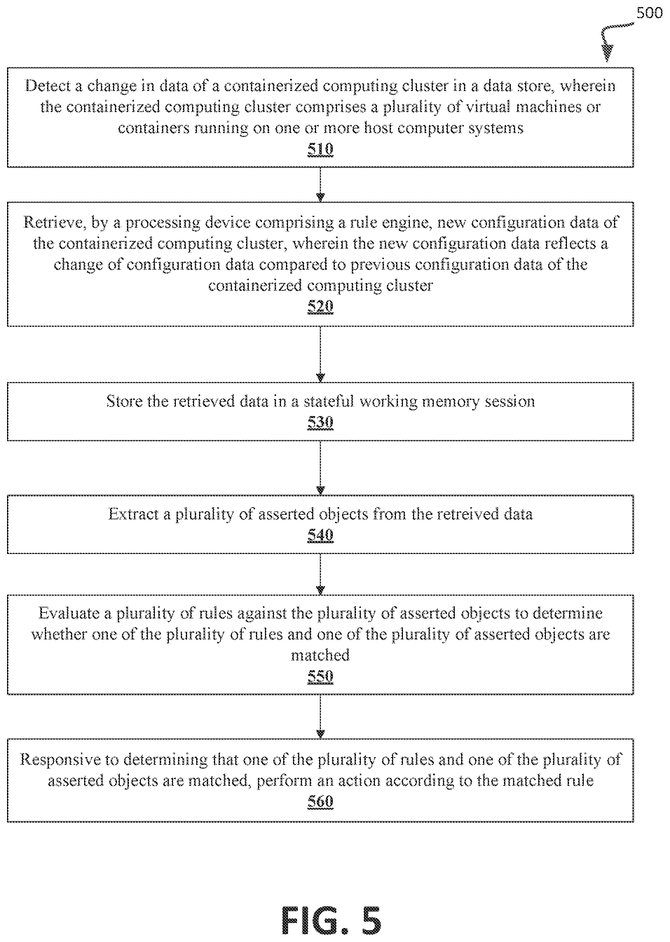

FIG. 5 depicts a flow diagram of an illustrative example of a method 500 for implementing a rule engine with push mechanism to retrieve new data of a containerized computing cluster, in accordance with one or more aspects of the present disclosure. Method 500 and each of its individual functions, routines, subroutines, or operations may be performed by one or more processors of the computer device executing the method. In certain implementations, method 500 may be performed by a single processing thread. Alternatively, method 500 may be performed by two or more processing threads, each thread executing one or more individual functions, routines, subroutines, or operations of the method. In an illustrative example, the processing threads implementing method 500 may be synchronized (e.g., using semaphores, critical sections, and/or other thread synchronization mechanisms). Alternatively, the processes implementing method 500 may be executed asynchronously with respect to each other.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media.

Method 500 may be performed by processing devices of a server device or a client device. The processing device includes a rule engine that is capable to create rules and evaluate rules. At operation 510, the processing logic detects a change in configuration data of a containerized computing cluster in a data store, wherein the containerized computing cluster comprises a plurality of virtual machines or containers running on one or more host computer systems.

At operation 520, the processing logic retrieves new configuration data of a containerized computing cluster, wherein the new configuration data reflects a change of configuration data compared to previous configuration data of the containerized computing cluster. The operation 520 may be the same as or similar to operation 410. The processing logic may retrieve the new configuration data when a change in data of the containerized computing cluster is detected.

At operation 530, the processing logic stores the retrieved data in a working memory in a stateful session. As described previously, in the stateful session, new rules and asserted objects can be added. As such, the working memory in the stateful session can store old data and the new configuration data.

At operation 540, the processing logic extracts a plurality of asserted objects from the retrieved data. The processing logic may select data from the retrieved data to be asserted objects. The processing logic may calculate data selected from the retrieved data to obtain the asserted objects.

At operation 550, the processing logic evaluates a plurality of rules against the plurality of asserted objects to determine whether one of the plurality of rules and one of the plurality of asserted objects are matched, which may be the same as or similar to operation 420. Specifically, the processing logic may determine whether the condition specified by each rule matches one or more asserted objects. Each of the plurality of rules may, when evaluated, use the retrieved data. For example, each rule may be a rule regarding a change of a state of the containerized computing cluster, and objects, extracted from the retrieved data, corresponding to the change of the state of the containerized computing cluster may be used to evaluate the rule. In some examples, the rule may include a constraint regarding a change of the state of the containerized computing cluster, and the processing logic compares the objects corresponding to the change of the state of the containerized computing cluster to the constraint regarding the change of the state of the containerized computing cluster. A rule can be related to one or more states of the containerized computing cluster.

At operation 560, the processing logic, responsive to determining that one of the plurality of rules and one of the plurality of asserted objects are matched, performs an action according to the matched rule, which may be the same as or similar to operation 430. As described previously, each rule can be evaluated by comparing with specific asserted object(s), and the matched rules can be obtained. The processing logic may perform the actions according to production sides of matched rules. In some implementations, the proceeding logic can decide an order of the plurality of actions to perform. In some implementations, the proceeding logic can decide a priority of the plurality of actions to perform.

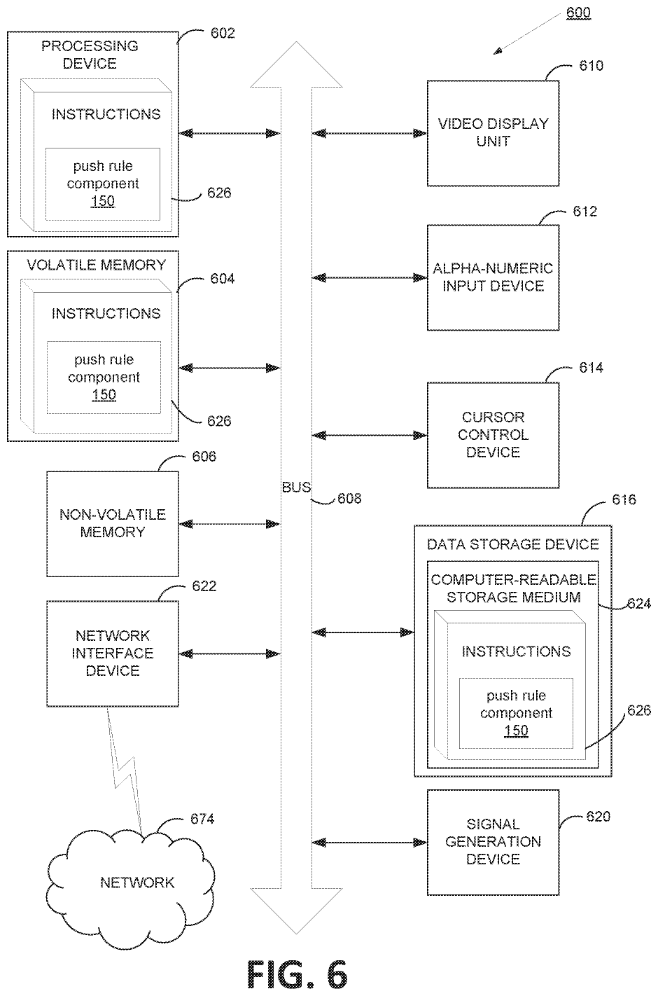

FIG. 6 depicts an example computer system 600, which can perform any one or more of the methods described herein. In one example, computer system 600 may correspond to computer system 100 of FIG. 1. The computer system may be connected (e.g., networked) to other computer systems in a LAN, an intranet, an extranet, or the Internet. The computer system may operate in the capacity of a server in a client-server network environment. The computer system may be a personal computer (PC), a set-top box (STB), a server, a network router, switch or bridge, or any device capable of executing a set of instructions (sequential or otherwise) that specify actions to be taken by that device. Further, while a single computer system is illustrated, the term “computer” shall also be taken to include any collection of computers that individually or jointly execute a set (or multiple sets) of instructions to perform any one or more of the methods discussed herein.

The exemplary computer system 600 includes a processing device 602, a main memory 604 (e.g., read-only memory (ROM), flash memory, dynamic random access memory (DRAM) such as synchronous DRAM (SDRAM)), a static memory 606 (e.g., flash memory, static random access memory (SRAM)), and a data storage device 616, which communicate with each other via a bus 608.

Processing device 602 represents one or more general-purpose processing devices such as a microprocessor, central processing unit, or the like. More particularly, the processing device 602 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 602 may also be one or more special-purpose processing devices such as an application-specific integrated circuit (ASIC), a field-programmable gate array (FPGA), a digital signal processor (DSP), network processor, or the like. The processing device 602 is configured to execute processing logic (e.g., instructions 626) that includes the push rule component 150 for performing the operations and steps discussed herein (e.g., corresponding to the method of FIGS. 4-5, etc.).

The computer system 600 may further include a network interface device 622. The computer system 600 also may include a video display unit 610 (e.g., a liquid crystal display (LCD) or a cathode ray tube (CRT)), an alphanumeric input device 612 (e.g., a keyboard), a cursor control device 614 (e.g., a mouse), and a signal generation device 620 (e.g., a speaker). In one illustrative example, the video display unit 610, the alphanumeric input device 612, and the cursor control device 614 may be combined into a single component or device (e.g., an LCD touch screen).

The data storage device 616 may include a non-transitory computer-readable medium 624 on which may store instructions 626 that include push rule component 150 (e.g., corresponding to the methods of FIGS. 4-5, etc.) embodying any one or more of the methodologies or functions described herein. Push rule component 150 may also reside, completely or at least partially, within the main memory 604 and/or within the processing device 602 during execution thereof by the computer system 600, the main memory 604, and the processing device 602 also constituting computer-readable media. Push rule component 150 may further be transmitted or received via the network interface device 622.

While the computer-readable storage medium 624 is shown in the illustrative examples to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding, or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media. Other computer system designs and configurations may also be suitable to implement the systems and methods described herein.

Although the operations of the methods herein are shown and described in a particular order, the order of the operations of each method may be altered so that certain operations may be performed in an inverse order or so that certain operations may be performed, at least in part, concurrently with other operations. In certain implementations, instructions or sub-operations of distinct operations may be in an intermittent and/or alternating manner.

It is to be understood that the above description is intended to be illustrative and not restrictive. Many other implementations will be apparent to those of skill in the art upon reading and understanding the above description. Therefore, the scope of the disclosure should be determined with reference to the appended claims, along with the full scope of equivalents to which such claims are entitled.

In the above description, numerous details are set forth. However, it will be apparent to one skilled in the art that aspects of the present disclosure may be practiced without these specific details. In some instances, well-known structures and devices are shown in block diagram form rather than in detail in order to avoid obscuring the present disclosure.

Unless specifically stated otherwise, as apparent from the following discussion, it is appreciated that throughout the description, discussions utilizing terms such as “receiving,” “determining,” “providing,” “selecting,” “provisioning,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for specific purposes, or it may comprise a general-purpose computer selectively activated or reconfigured by a computer program stored in the computer. Such a computer program may be stored in a computer-readable storage medium, such as, but not limited to, any type of disk, including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Aspects of the disclosure presented herein are not inherently related to any particular computer or other apparatus. Various general-purpose systems may be used with programs in accordance with the teachings herein, or it may prove convenient to construct a more specialized apparatus to perform the specified method steps. The structure for a variety of these systems will appear as set forth in the description below. In addition, aspects of the present disclosure are not described with reference to any particular programming language. It will be appreciated that a variety of programming languages may be used to implement the teachings of the disclosure as described herein.

Aspects of the present disclosure may be provided as a computer program product that may include a machine-readable medium having stored thereon instructions, which may be used to program a computer system (or other electronic devices) to perform a process according to the present disclosure. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read-only memory (“ROM”), random access memory (“RAM”), magnetic disk storage media, optical storage media, flash memory devices, etc.).

The words “example” or “exemplary” are used herein to mean serving as an example, instance, or illustration. Any aspect or design described herein as “example” or “exemplary” is not to be construed as preferred or advantageous over other aspects or designs. Rather, the use of the words “example” or “exemplary” is intended to present concepts in a concrete fashion. As used in this application, the term “or” is intended to mean an inclusive “or” rather than an exclusive “or.” That is, unless specified otherwise or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, the use of the term “an embodiment” or “one embodiment” or “an implementation” or “one implementation” throughout is not intended to mean the same embodiment or implementation unless described as such. Furthermore, the terms “first,” “second,” “third,” “fourth,” etc., as used herein, are meant as labels to distinguish among different elements and may not have an ordinal meaning according to their numerical designation.

What is claimed is:

1. A method comprising:
retrieving, by a processing device, new configuration data of a containerized computing cluster, wherein the containerized computing cluster comprises a plurality of virtualized computing environments running on one or more host computer systems, and wherein the new configuration data reflects a change of a configuration of the containerized computing cluster with respect to a previous configuration of the containerized computing cluster;
storing the new configuration data into a working memory, wherein the working memory is in a stateful session;
extracting a fact from the new configuration data;
evaluating a rule against the fact, wherein the rule specifies a condition and an action to perform if the condition is satisfied; and
responsive to determining that the condition specified by the rule matches the fact, performing the action specified by the rule, wherein the action comprises a notification regarding a change of a state of the containerized computing cluster.

2. The method of claim 1, further comprising:
detecting a change in configuration data of the containerized computing cluster in a data store of the containerized computing cluster.

3. The method of claim 2, wherein retrieving the new configuration data is performed responsive to detecting the change in the configuration data of the containerized computing cluster in the data store.

4. The method of claim 1, wherein the new configuration data is retrieved from a data store of the containerized computing cluster.

5. The method of claim 4, wherein retrieving the new configuration data is performed responsive to determining that the new configuration data in the data store satisfies a threshold condition.

6. The method of claim 1, wherein the new configuration data of the containerized computing cluster comprises at least one of a desired state or a current state of the containerized computing cluster.

7. The method of claim 1, wherein the action comprises a corrective action with respect to the change of the state of the containerized computing cluster.

8. A system comprising:
a memory;
a processing device coupled to the memory, the processing device to perform operations comprising:
retrieving, by a processing device, new configuration data of a containerized computing cluster, wherein the containerized computing cluster comprises a plurality of virtualized computing environments running on one or more host computer systems, and wherein the new configuration data reflects a change of a configuration of the containerized computing cluster with respect to a previous configuration of the containerized computing cluster;
storing the new configuration data into a working memory, wherein the working memory is in a stateful session;
extracting a fact from the new configuration data;
evaluating a rule against the fact, wherein the rule specifies a condition and an action to perform if the condition is satisfied; and
responsive to determining that the condition specified by the rule matches the fact, performing the action specified by the rule, wherein the action comprises a notification regarding a change of a state of the containerized computing cluster.

9. The system of claim 8, wherein the processing device to further perform operations comprising:
detecting a change in configuration data of the containerized computing cluster in a data store of the containerized computing cluster.

10. The method of claim 9, wherein retrieving the new configuration data is performed responsive to detecting the change in the configuration data of the containerized computing cluster in the data store.

11. The system of claim 8, wherein the new configuration data is retrieved from a data store of the containerized computing cluster.

12. The system of claim 11, wherein retrieving the new configuration data is performed responsive to determining that the new configuration data in the data store satisfies a threshold condition.

13. The system of claim 8, wherein the new configuration data of the containerized computing cluster comprises at least one of a desired state or a current state of the containerized computing cluster.

14. The system of claim 8, wherein the action comprises a corrective action with respect to the change of the state of the containerized computing cluster.

15. A non-transitory computer-readable storage medium comprising instructions that, when executed by a processing device, cause the processing device to perform operations comprising:
retrieving, by a processing device, new configuration data of a containerized computing cluster, wherein the containerized computing cluster comprises a plurality of virtualized computing environments running on one or more host computer systems, and wherein the new configuration data reflects a change of a configuration of the containerized computing cluster with respect to a previous configuration of the containerized computing cluster;
storing the retrieved data in a working memory in a stateful session;
extracting a fact from the new configuration data;
evaluating a rule against the fact, wherein the rule specifies a condition and an action to perform if the condition is satisfied; and
responsive to determining that the condition specified by the rule matches the fact, performing the action specified by the rule, wherein the action comprises a notification regarding a change of a state of the containerized computing cluster.

16. The non-transitory computer-readable storage medium of claim 15, wherein the processing device to further perform operations comprising:
detecting a change in configuration data of the containerized computing cluster in a data store of the containerized computing cluster.

17. The non-transitory computer-readable storage medium of claim 16, wherein retrieving the new configuration data is performed responsive to detecting the change in the configuration data of the containerized computing cluster in the data store.

18. The non-transitory computer-readable storage medium of claim 15, wherein the new configuration data is retrieved from a data store of the containerized computing cluster.

19. The non-transitory computer-readable storage medium of claim 18, wherein retrieving the new configuration data is performed responsive to determining that the new configuration data in the data store satisfies a threshold condition.

20. The non-transitory computer-readable storage medium of claim 15, wherein the action comprises a corrective action with respect to the change of the state of the containerized computing cluster.
